(19) United States
(12) Patent Application Publication
(10) Pub. No.: US 2025/0382544 A1
(43) Pub. Date: Dec. 18, 2025

(54) DETERGANT PARTICLES CONTAINING POLYMER AND SURFACTANT

(71) Applicant: The Procter & Gamble Company, Cincinnati, OH (US)

(72) Inventors: Xin LI, Beijing (CN); Dan XU, Beijing (CN); Gang SI, Newcastle upon Tyne (GB); Rui SHEN, Beijing (CN); Mark Robert SIVIK, Mason, OH (US)

(21) Appl. No.: 19/234,368

(22) Filed: Jun. 11, 2025

(30) Foreign Application Priority Data
Jun. 14, 2024 (WO) PCT/CN2024/099176

(51) Int. Cl. C11D 1/22; C11D 1/12; C11D 1/37; C11D 3/37; C11D 17/04

(52) U.S. Cl. CPC C11D 1/22; C11D 1/123; C11D 1/37; C11D 3/3723; C11D 17/044; C11D 2111/12

(57) ABSTRACT

A particulate composition includes a high active linear alkyl benzene sulphonate (LAS) and an ethoxylated polyethyleneimine. A cleaning composition in solid form includes the same. The detergent particle shows good flowability.

### FIELD OF THE INVENTION

The present invention relates to a detergent particle comprising high active linear alkyl benzene sulphonate (LAS) and ethoxylated polyethyleneimine.

### BACKGROUND OF THE INVENTION

As part of the strategy to drive sustainability, the detergent industry has globally engaged in various efforts to drive compaction. Compaction typically means that the product is in a form that uses more active ingredients and less non-active ingredients (such as water, non-active solvents, and fillers). As a result, consumers can reduce the dose of detergent per wash but still achieve the desired wash result. Compaction can further translate to savings in packaging materials, savings in transportation cost, reduced product CO₂ emissions, etc. Active ingredient raw materials available at high active level made from viable industrial process has been a key to enable compaction.

Linear alkylbenzene sulphonate (“LAS”) is one of the most commonly used cleaning actives in powder detergent formulations. Detergent granules containing LAS can be readily formed by different processes, e.g. agglomeration and spray drying. For example, the liquid acid precursor of LAS, which is the linear alkylbenzene sulphonic acid and is typically referred to as “HLAS,” can be mixed with an aqueous solution of sodium hydroxide (i.e., caustic) to form a substantially neutralized LAS paste, which is then mixed with other powder ingredients to form the detergent granules. Such LAS paste has a relatively high water content, because not only the sodium hydroxide solution introduce water into the mixture, but also the neutralization reaction between HLAS and NaOH generates water as a reaction by-product. Such relatively high water content must be subsequently removed from the detergent granules in order to preserve the free flow characteristic of the dry powder detergents and avoid undesirable “caking” of the finished product. Subsequent water removal is typically achieved by drying, which is an energy and capital-demanding process.

It is desired to provide a high active LAS particle to be used in compact detergent. However, there is a challenge on flowability for detergent granules containing high active LAS. For example, commercially available LAS particles have about 30% active level. There is a continuous need to provide a high active LAS-containing detergent granule, exhibiting desirable or improved flowability. Adding inorganic or organic fillers into LAS particle could be a solution for providing good flowability, but it is always desirable to minimize usage of non-active ingredients.

The inventors have surprisingly found specific polymers (i.e., ethoxylated polyethyleneimine) can be incorporated into detergent particles that comprise high level of LAS surfactant. Said ethoxylated polyethyleneimine polymer surprisingly helps to form a high active LAS-containing particle and provide superior flowability during manufacturing and usage.

### SUMMARY OF THE INVENTION

In one aspect, the present invention relates to a detergent particle comprising:
(a) from 50% to 90%, by weight of the detergent particle, an alkyl benzene sulphonate anionic surfactant; and
(b) from 0.1% to 20%, by weight of the detergent particle, an ethoxylated polyethyleneimine.

Preferably, the alkyl benzene sulphonate anionic surfactant contained in the detergent particle is a C₁₀-C₂₀ linear alkyl benzene sulphonate. In preferred embodiments, the alkyl benzene sulphonate anionic surfactant is a sodium salt of C₁₀-C₂₀ linear alkyl benzene sulphonate. In some preferred embodiments, the alkyl benzene sulphonate anionic surfactant is present in an amount of from 60% to 95%, more preferably from 65% to 93%, alternatively from 70% to 90%, or 75% to 90%, by weight of the detergent particle.

Preferably, the ethoxylated polyethyleneimine comprises a polyethyleneimine backbone of weight average molecular weight of between 100 g/mol and 5000 g/mol. More preferably, the ethoxylated polyethyleneimine comprises a polyethyleneimine backbone of weight average molecular weight of between 400 g/mol and 1500 g/mol. In some embodiments, the ethoxylated polyethyleneimine comprises polyoxyethylene side chains having an average of from 5 to 40 ethoxy units per side chain bonded to the polyethyleneimine backbone, preferably the ethoxylated polyethyleneimine comprises polyoxyethylene side chains having an average of from 10 to 30 ethoxy units per side chain bonded to the polyethyleneimine backbone.

In some embodiments, the ethoxylated polyethyleneimine comprises: a polyethyleneimine backbone of weight average molecular weight of between 450 g/mol and 750 g/mol; and polyoxyethylene side chains having an average of from 15 to 25 ethoxy units per NH moiety in the polyethyleneimine backbone. Preferably, the ethoxylated polyethyleneimine has a total weight average molecular weight of from 7500 g/mol to 17500 g/mol. An ethoxylated polyethyleneimine that can be used is commercially available from BASF under the tradename Sokalan HP 20.

In some embodiments, the detergent particle further comprises from 0.01% to 5%, by weight of the detergent particle, of sodium sulfosuccinate.

In some embodiments, the detergent particle is characterized by: (1) a particle size distribution Dw50 of from 100 μm to 1000 μm; (2) a bulk density of from 400 to 1000 g/L; and (3) a moisture content of from 0 wt % to 8 wt %, preferably from 0 wt % to 3 wt %.

In another aspect, the present invention relates to a cleaning composition in solid form, comprising from 0.1% to 99%, preferably from 5% to 90%, by weight of the composition, of the detergent particle described herein, and from 0.1% to 99%, by weight of the composition, of an additional ingredient, wherein the additional ingredient is selected from the group consisting of perfume, perfume encapsulates, surfactants, polymers, enzymes, bleach, bleach activators, phosphates, zeolite, silicates, carbonates, sodium chloride, chelants, hueing agents, dye transfer inhibitors, and any combinations thereof.

In another aspect, the present invention relates to a method for making the detergent particle described herein.

In another aspect, the present invention relates to a water-soluble unit dose article comprising the detergent particle described herein.

In another aspect, the present invention relates to a method for using the cleaning composition in solid form, which contains the detergent particles described herein and additional ingredients.

In another aspect, the present invention relates to detergent particles being made in various forms to include but not limited to granular, regular or irregular spherical, flake, or powder.

In another aspect, the present invention relates to a method for treating laundry with the cleaning composition described herein.

An advantage of the present invention is to provide a detergent particle comprising high active LAS and ethoxylated polyethyleneimine polymers to show good compatibility with the specific making process of the particle.

Another advantage of the present invention is to provide a detergent particle comprising high active LAS and ethoxylated polyethyleneimine polymers to show good flowability, and good storage stability.

Another advantage of the present invention is to provide a detergent particle comprising high active LAS and ethoxylated polyethyleneimine polymers showing good cleaning benefit when used in a cleaning composition in solid form.

These and other aspects of the present invention will become more apparent upon reading the following detailed description of the invention.

### DETAILED DESCRIPTION OF THE INVENTION

Features and benefits of the various embodiments of the present invention will become apparent from the following description, which includes examples of specific embodiments intended to give a broad representation of the invention. Various modifications will be apparent to those skilled in the art from this description and from practice of the invention. The scope of the present invention is not intended to be limited to the particular forms disclosed and the invention covers all modifications, equivalents, and alternatives falling within the spirit and scope of the invention as defined by the claims.

As used herein, articles such as “a” and “an” when used in a claim, are understood to mean one or more of what is claimed or described. The terms “comprise,” “comprises,” “comprising,” “contain,” “contains,” “containing,” “include,” “includes” and “including” are all meant to be non-limiting.

As used herein, the term “cleaning composition” means a liquid or solid composition, and includes, unless otherwise indicated, granular or powder-form all-purpose or “heavy-duty” washing agents, especially cleaning detergents, for fabrics, as well as cleaning auxiliaries such as bleach, rinse aids, additives, or pre-treat types; hand dishwashing agents or light duty dishwashing agents, especially those of the high-foaming type; machine dishwashing agents; mouthwashes, denture cleaners, car or carpet shampoos, bathroom cleaners; hair shampoos and hair-rinses; shower gels and foam baths and metal cleaners; as well as cleaning auxiliaries such as bleach additives or pre-treat types. In one preferred aspect, the cleaning composition is a solid laundry detergent composition, and more preferably a free-flowing particulate laundry detergent composition (i.e., a granular laundry detergent product).

As used herein, the term “detergent particle” means a solid cleaning composition or a solid detergent composition, preferably a free-flowing particulate detergent composition (i.e., a granular detergent product). In one preferred aspect, the detergent particle is a granular laundry detergent product.

As used herein, the phrases “water-soluble unit dose article,” “water-soluble fibrous structure”, and “water-soluble fibrous element” mean that the unit dose article, fibrous structure, and fibrous element are miscible in water. In other words, the unit dose article, fibrous structure, or fibrous element is capable of forming a homogeneous solution with water at ambient conditions. “Ambient conditions” as used herein means 23° C.±1.0° C. and a relative humidity of 50%±2%. The water-soluble unit dose article may contain insoluble materials, which are dispersible in aqueous wash conditions to a suspension mean particle size that is less than about 20 microns, or less than about 50 microns.

As used herein, the terms “consisting essentially of” means that the composition contains less than about 1%, preferably less than about 0.5%, of ingredients other than those listed.

Further, the terms “essentially free of”, “substantially free of” or “substantially free from” means that the indicated material is present in the amount of from 0 wt % to about 0.5 wt %, or preferably from 0 wt % to about 0.1 wt %, or more preferably from 0 wt % to about 0.01 wt %, and most preferably it is not present at analytically detectable levels. The term “substantially pure” or “essentially pure” means that the indicated material is present in the amount of from about 99.5 wt % to about 100 wt %, preferably from about 99.9 wt % to about 100 wt %, and more preferably from 99.99 wt % to about 100 wt %, and most preferably all other materials are present only as impurities below analytically detectable levels.

As used herein, the term “water-soluble” refers to a solubility of more than about 30 grams per liter (g/L) of deionized water measured at 20° C. and under atmospheric pressure.

As used herein, all concentrations and ratios are on a weight basis unless otherwise specified. All temperatures herein are in degrees Celsius (° C.) unless otherwise indicated. All conditions herein are at 20° C. and under atmospheric pressure, unless otherwise specifically stated. All polymer molecular weights are determined by weight average molecular weight unless otherwise specifically noted.

### Detergent Particle

The detergent particle of the present invention comprises a relatively high amount of alkyl benzene sulphonate anionic surfactant (LAS) and an ethoxylated polyethyleneimine.

Preferably, the detergent particle is characterized by: (1) a particle size distribution Dw50 of from 100 μm to 1000 μm, preferably from 150 μm to 800 μm; (2) a bulk density of from 400 to 1000 g/L; and (3) a moisture content of from 0 wt % to 8 wt %, preferably from 0 wt % to 3 wt %. Preferably, the detergent particle is a solid free-flowing particle.

### Alkyl Benzene Sulphonate Anionic Surfactant

The detergent particle comprises from 50% to 95%, by weight of the detergent particle, an alkyl benzene sulphonate anionic surfactant. Preferably, the alkyl benzene sulphonate anionic surfactant is present in an amount of from 60% to 93%, more preferably from 65% to 90%, alternatively from 70% to 95%, or 75% to 90%, by weight of the detergent particle.

Preferably, the alkyl benzene sulphonate anionic surfactant contained in the detergent particle is a C₁₀-C₂₀ linear alkyl benzene sulphonate (LAS). LAS anionic surfactants are well known in the art and can be readily obtained by sulphonating commercially available linear alkylbenzenes. Suitable LAS is obtainable, preferably obtained, by sulphonating commercially available linear alkyl benzene (LAB). Suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable anionic surfactant is alkyl benzene sulphonate that is obtained by DETAL catalyzed process, although other synthesis routes, such as HF, may also be suitable. In one aspect a magnesium salt of LAS is used.

Suitable LAS may comprise a component obtained from waste plastic feedstock. Preferably LAS obtained from waste plastic feedstock comprises from 0.001 to 100% wt. of the total LAS, more preferably from 0.01% to 50 wt. %, more preferably from 0.1% to 20 wt. %, most preferably from 0.5% to 10%. Suitable LAS obtained from waste plastic feedstock are described for example in WO2023057604, WO2023057531 and WO2023057530.

Exemplary C₁₀-C₂₀ LAS that can be used in the present invention include alkali metal, alkaline earth metal or ammonium salts of C₁₀-C₂₀ linear alkylbenzene sulphonic acids, and preferably the sodium, potassium, magnesium and/or ammonium salts of C₁₁-C₁₈ or C₁-C₁₄ linear alkylbenzene sulphonic acids. More preferred are the sodium or potassium salts of C₁₂ linear alkylbenzene sulphonic acids, and most preferred is the sodium salt of C₁₂ linear alkylbenzene sulphonic acid, i.e., sodium dodecylbenzene sulphonate.

Preferably, the LAS is selected from C₁₀-C₁₆ linear alkyl benzene sulfonic acids, alkali metal or amine salts of C₁₀-C₁₆ linear alkyl benzene sulfonic acids, wherein the HLAS surfactant comprises greater than 50% C₁₂, preferably greater than 60%, preferably greater than 70% C₁₂, more preferably greater than 75%.

The detergent particle of the present invention provides the LAS being present at a significantly higher level, e.g., from about 50% to about 95%, preferably from about 55% to about 90%, and more preferably from about 60% to about 90%, by weight of the detergent particle. This is achieved by incorporating a polyester soil release polymer, which not only provides active soil release benefit, but also surprisingly helps constituting high-LAS particle with desirable flowability, density and solubility.

### Ethoxylated Polyethyleneimine

The detergent particle comprises from 0.1% to 20%, preferably from 0.2% to 18%, more preferably from 0.5% to 15%, by weight of the particle, an ethoxylated polyethyleneimine.

Ethoxylated polyethyleneimine (EPEI) is an effective dispersing agent for hydrophilic stains, especially hydrophilic particulate stains such as clay. The ethoxylated polyethyleneimine in the detergent particle comprises:
a polyethyleneimine core, and
polyalkylene oxide side chains bonded to the NH moiety of polyethyleneimine backbone,
wherein at least one of the polyalkylene oxide side chains comprises polyethylene oxide structural unit.

Typically, the polyethylene oxide structural unit has a structure of

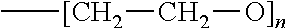

wherein
n has an average value in the range of 5 to 50; and

The ethoxylated polyethyleneimine has the PEG content from 40% to 99%.

Herein, the PEG content of the ethoxylated polyethyleneimine is defined as below:

$$PEG content = \frac{Total MW of polyethylene glycol moiety within the polymer}{MW of the polymer} \times 100 \%$$

In some embodiments, PEG content of a ethoxylated polyethyleneimine can be calculated based on dosage of reactant used to make the polymer. In some embodiment, PEG content can be measured using analytical method, such as NMR.

In one embodiment, the EPEI has a polyethyleneimine backbone of weight average molecular weight of between 100 g/mol and 2000 g/mol, preferably between 200 g/mol and 1500 g/mol, more preferably between 300 g/mol and 1000 g/mol, even more preferably between 400 g/mol and 800 g/mol, most preferably between 500 g/mol and 700 g/mol, preferably about 600. The ethoxylation chains within the EPEI may be from 200 g/mol to 2000 g/mol weight average molecular weight, preferably from 400 g/mol to 1500 g/mol weight average molecular weight, more preferably from 600 g/mol to 1000 g/mol weight average molecular weight, most preferably about 880 g/mol weight average molecular weight per ethoxylated chain. The ethoxylation chains within the EPEI have on average 5 to 40, preferably 10 to 30, more preferably 15 to 25, even more preferably 18 to 22, most preferably about 20 ethoxy units per ethoxylation chain. The EPEI may have a total weight average molecular weight of from 5000 g/mol to 20000 g/mol, preferably from 7500 g/mol to 17500 g/mol, more preferably from 10000 g/mol to 15000 g/mol, even more preferably from 12000 g/mol to 13000 g/mol, most preferably about 12700 g/mol. A preferred example is polyethyleneimine core (with average molecular weight about 600 g/mol) ethoxylated to 20 EO groups per NH. Preferably, the PEG content of the ethoxylated polyethyleneimine is between 80% to 99%, preferably between 85% to 98%, preferably between 90% to 95%, such as 92%, 94%. Suitable EPEI this type includes Sokalan HP20 available from BASF, Lutensol FP620 from BASF. Examples of available polyethyleneimine ethoxylates also include those prepared by reacting ethylene oxide with Epomine SP-006 manufactured by Nippon Shokubai.

In another embodiment, the EPEI comprises polyethyleneimine has an average molecular weight (Mw) ranging from 1800 to 5000 g/mol (prior to ethoxylation), and the polyoxyethylene side chains have an average of from 25 to 40 ethoxy units per side chain bonded to the NH moiety of polyethyleneimine backbone. Such EPEI is described in WO2020/030760 and WO2020/030469.

Suitable ethoxylated polyethyleneimine may further comprise structural units derived from alkylene oxide different from ethylene oxide. This type of ethoxylated polyethylene imine can be referred as alkoxylated polyethyleneimine polymer. These polymers have balanced hydrophilic and hydrophobic properties such that they remove grease and body soil particles from fabrics and surfaces, and keep the particles suspended in washing liquor. Suitable amphiphilic water-soluble alkoxylated polyethyleneimine is described in WO2009/061990 and WO2006/108857, which comprising a polyethyleneimine core, and alkoxylate group of below connected to the core

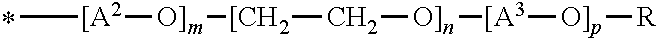

wherein
“*” in each case denotes one-half of bond to the nitrogen atom of the core.
A² is in each case independently selected from 1,2-propylene, 1,2-butylene, and 1,2-isobutylene;
A³ is 1,2-propylene;
R is in each case independently selected from hydrogen and C₁-C₄-alkyl, preferably hydrogen;
m has an average value in the range of from 0 to 2, preferably 0;
n has an average value in the range of 5 to 50; and
p has an average value in the range of 3-50;
wherein, the [CH₂—CH₂—O]ₙ is the “ethoxylation” derived from ethylene oxide.

Preferably, the PEG content of the alkoxylated polyethyleneimine is between 40% to 95%, preferably between 42% to 85%, preferably between 44% to 75%, preferably between 46% to 65%, preferably between 48% to 60%, such as 50%, 53%, 55%, 58%.

The polymer comprises a degree of quaternization ranging from 0 to 50, preferably from 0 to 20, and more preferably from 0 to 10.

A preferred alkoxylated polyethyleneimine is polyethyleneimine (MW=600) modified with 24 ethoxylate groups per —NH and 16 propoxylate groups per —NH. Another preferred alkoxylated polyethyleneimine is polyethyleneimine (MW=600) modified with 10 ethoxylate groups per —NH and 7 propoxylate groups per —NH. This polymer has a PEG content of between 45% to 55%.

Suitable alkoxylated polyethyleneimine of this type includes Sokalan HP30 Booster available from BASF. This polymer has a PEG content of This polymer has a PEG content of between 45% to 55%.

### Other Ingredients

The detergent particles according to the present disclosure may be combined with an additional ingredient. For example, the detergent particle further comprises from 0.01% to 5%, preferably from 0.1% to 4%, more preferably from 0.5% to 3%, by weight of the detergent particle, of sodium sulfosuccinate. The addition of sodium sulfosuccinate helps to stabilize the high active LAS-containing detergent particles.

The additional ingredients may be in the form of particulates, such as agglomerates and/or spray-dried powder. Alternatively, the additional ingredients may be sprayed onto the surface of the particulate composition according to the present disclosure. Preferably, the additional ingredient may be selected from the group consisting of polymers, perfume, perfume encapsulates, surfactants, enzymes, brighteners, bleach, bleach activators, phosphates, zeolite, silicates, carbonates, sodium chloride, and any combinations thereof.

### Particulate Cleaning Composition Containing Detergent Particle

The cleaning composition is a laundry detergent composition in a solid form. Suitable laundry detergent compositions in solid form include any detergent composition comprising ingredient in solid form. The cleaning composition in solid form can be in the form of an agglomerate, granule, flake, extrudate, bar, tablet, powder, bead, sheet, fibrous article, and single or multi-compartment water-soluble unit dose detergent.

When the cleaning composition in solid form is a multi-compartment water-soluble unit dose detergent, at least one of the compartments comprises detergent particles according to this invention. Preferably, the single or multi-compartment water-soluble unit dose detergent comprises polyvinyl alcohol. More Preferably, the composition is partially enclosed, or completely enclosed, by a film such as a polyvinyl alcohol film.

The cleaning composition may also be in the form of an insoluble substrate, for example a non-woven sheet, impregnated with detergent actives.

The solid composition typically has a bulk density of from 300 g/l to 1,500 g/1, typically from 500 g/l to 1,000 g/1.

The cleaning composition may also be in the form of an insoluble substrate, for example a non-woven sheet, impregnated with detergent actives.

The cleaning composition may be capable of cleaning and/or softening fabric during a laundering process. Typically, the composition is formulated for use in an automatic washing machine or for hand-washing use, and preferably for hand-wash.

### Methods of Using the Cleaning Composition

The compositions are typically used for cleaning and/or treating a situs inter alia a surface or fabric. As used herein, “surface” may include such surfaces such as dishes, glasses, and other cooking surfaces, hard surfaces, hair or skin. Such method includes the steps of contacting an embodiment of the laundry detergent or cleaning composition, in neat form or diluted in a wash liquor, with at least a portion of a surface or fabric, then optionally rinsing such surface or fabric. The surface or fabric may be subjected to a washing step prior to the aforementioned rinsing step. For purposes of the present invention, “washing” includes but is not limited to, scrubbing, wiping, and mechanical agitation.

The composition solution pH is chosen to be the most complimentary to a target surface to be cleaned spanning broad range of pH, from about 5 to about 11. For personal care such as skin and hair cleaning pH of such composition preferably has a pH from about 5 to about 8 for laundry cleaning compositions pH of from about 8 to about 10. The compositions are preferably employed at concentrations of from about 200 ppm to about 10,000 ppm in solution. The water temperatures preferably range from about 5° C. to about 100° C.

As will be appreciated by one skilled in the art, the laundry detergent of the present invention is ideally suited for use in laundry applications. Accordingly, the present invention includes a method for laundering fabric. The method may comprise the steps of contacting a fabric to be laundered with a laundry detergent comprising the carboxyl group-containing polymer. The fabric may comprise most of any fabric capable of being laundered in normal consumer use conditions. The solution preferably has a pH of from about 8 to about 10.5. The laundry detergent may be employed at concentrations of from about 500 ppm to about 15,000 ppm in solution, and optionally, more dilute wash conditions can be used. The water temperatures typically range from about 5° C. to about 90° C. The water to fabric ratio is typically from about 1:1 to about 30:1.

The method of laundering fabric may be carried out in a top-loading or front-loading automatic washing machine or can be used in a hand-wash laundry application. In these applications, the wash liquor formed and concentration of laundry detergent composition in the wash liquor is that of the main wash cycle. Any input of water during any optional rinsing step(s) is not included when determining the volume of the wash liquor.

The wash liquor may comprise 40 litres or less of water, or 30 litres or less, or 20 litres or less, or 10 litres or less, or 8 litres or less, or even 6 litres or less of water. The wash liquor may comprise from above 0 to 15 litres, or from 2 litres, and to 12 litres, or even to 8 litres of water. For dilute wash conditions, the wash liquor may comprise 150 litres or less of water, 100 litres or less of water, 60 litres or less of water, or 50 litres or less of water, especially for hand washing conditions, and can depend on the number of rinses.

Typically, from 0.01 Kg to 2 Kg of fabric per litre of wash liquor is dosed into the wash liquor. Typically, from 0.01 Kg, or from 0.05 Kg, or from 0.07 Kg, or from 0.10 Kg, or from 0.15 Kg, or from 0.20 Kg, or from 0.25 Kg fabric per litre of wash liquor is dosed into the wash liquor.

Optionally, 50 g or less, or 45 g or less, or 40 g or less, or 35 g or less, or 30 g or less, or 25 g or less, or 20 g or less, or even 15 g or less, or even 10 g or less of the composition is contacted to water to form the wash liquor.

### Test Method

### 1. Ring Shear Test

The flowability (¦¦_{c}) of each sample detergent granule is the ratio of ai (consolidation stress) to σ_{c} (unconfined yield strength), which is used to characterize flowability numerically: the larger ¦¦_{c} means the better a bulk solid flow. The flowability (¦¦_{c}) data is generated from a Schulze Ring Shear Tester RST-XS, while the detailed test procedure of the ring shear tester is described in detail in ASTM standard D-6773.

The specific operating condition of the Schulze Ring Shear Tester RST-XS are described hereinafter. To run a flow-ability test, firstly fill sufficient pre-conditioned detergent granules into the shear cell and form a flat powder bed by scraping off the excess material with a spatula. The mass of the filled bottom ring is then weighed and recorded. Set the filled bottom ring on the ring shear tester and place the lid concentrically to the bottom ring on the bulk solid specimen. For preshear the bottom ring is rotated clockwise (seen from the top), whereby the lid is prevented from rotation by the tie rods. The consolidation stress at pre-shear is set as 16000 Pa, and five different other consolidation stresses (3200 Pa, 6400 Pa, 8000 Pa, 9600 Pa and 12800 Pa) are also applied during the same test. The minimum shear stress required to shear the bulk sample (shear to failure) at each consolidation stress is then measured to generate a yield locus (see FIG. 4.10 in D. Schulze, Powder and Bulk Solid: Behavior, Characterization, Storage and Flow, Springer, 2008). The yield locus is then used to calculate the consolidation stress, α1 and the unconfined yield strength, σ_{c}; and the ratio of σ₁ to σ_{c} is the flowability, ¦¦_{c}. The larger ffc is, i.e., the smaller the ratio of the unconfined yield strength, σ_{c}, to the consolidation stress, σ₁, the better bulk solid flows. Similar to the classification used by Jenike, one can define flow behavior as follows:
ff_{c}<1 not flowing
1<ff_{c}<2 very cohesive
2<ff_{c}<4 cohesive
4<ff_{c}<10 easy flowing
10<ff_{c} free flowing

### 2. Moisture Analysis

2.0 grams of a powder sample is tested in the Mettler Toledo HR73 Halogen Moisture analyzer at 110 deg C. for 30 minutes. The percentage of lost mass at the end of the measurement is recorded as the sample's moisture content. Ensure the moisture is below 1.0%.

### EXAMPLES

The detergent particles of the present invention can be made by the following exemplary process:

In the initial step, all the necessary ingredients for the surfactant formulation are blended to create a uniform surfactant slurry. The slurry undergoes a precisely controlled drying process to eliminate moisture and attain the desired dried produce with defined moisture target.

Subsequently, the particles are carefully sieved to achieve defined particle size distribution (PSD, see 1.1 for details). This meticulous process ensures that the resulting particles are optimized for the intended flowability test, enabling effective comparisons and evaluations.

### Example 1: Sample Preparation

### 1.1 Making Sample

A) In the 60 L emulsification tank, with the jacket temperature set at 60° C., combine the following ingredients: 4.40 kg of deionized water, 4.01 kg of 50% NaOH solution, and 0.72 kg of sodium sulfosuccinate. Add 15.55 kg of linear C10-16 alkyl benzene sulfonic acids (LAS) and 1.46 kg of deionized water. Additionally, introduce 3.67 kg of a non-surfactant salt solution, such as 18.2% sodium sulfate solution. Finally, incorporate one or more polymers into the mixture.
B) drying the Step A slurry to a solid material containing from about 0.5% to 3% by weight of water;
C) surfactant-containing solid formed in Step C to milling and sieving to get particles within defined particle distribution.
   1.2 Prepare Sample with Matched PSD
1. Prepare the RoTap apparatus by ensuring it is clean and in proper working condition.
2. Select the appropriate set of sieves with desired mesh sizes for the particle size range of interest (1180 um, 850 um, 600 um, 425 um, 150 um, and pan).
3. Weigh around 100 g sample to be analyzed, ensuring it is representative and properly homogenized.
4. Place the sample onto the top sieve of the RoTap stack.
5. Securely attach the sieve stack onto the RoTap and start the sieving process.
6. Set 5 min of sieving time.
7. After the sieving process is complete, carefully remove the sieves from the RoTap stack.
8. Collect the material retained on each sieve, ensuring to brush off any particles adhering to the sieve surfaces.
9. Weigh the material retained on each sieve to match the size as below distribution:

| Sieve | 1180 | 850 | 600 | 425 | 150 | 0 |
|---|---|---|---|---|---|---|
| PSD | 1% | 30% | 32% | 22% | 15% | 0% |

### Example 2: Exemplary Compositions of Detergent Particles

Exemplary formulations for particles described herein are set forth in Table 1.

Components for which multiple suitable materials are listed, all permutations of possible formulations are contemplated herein.

TABLE 1
Comparative and inventive Examples of
the detergent particle formulations

| Ingredients | Comparative | Inventive |
|---|---|---|
| (weight % of active) | Example A | Example B |
| NaLAS | 90% | 82% |
| Ethoxylated Polyethylenimine | 0% | 8% |
| Polymer* | | |
| Trisodium Sulfosuccinate | 2% | 2% |
| Sulfate | 5% | 5% |
| Water | 1% | 1% |
| Minors | balance | balance |

*600 g/mol molecular weight polyethylenimine core with 20 ethoxylate groups per —NH.

### Example 3: Flowability—Ring Shear Test

The Flowability of the Comparative and Inventive Examples are tested according to the Ring Shear Test described in Test Method hereinabove. The Results are listed in Table 2 below.

TABLE 2
flowability data (under 16 kPa)

| | Comparative | Inventive |
|---|---|---|
| | Example A | Example B |
| Flowability (¦¦_{c}) | 4.1 | 6.5 |
| Δ¦¦_{c} | — | 2.4 |

The results show clearly that the particle containing combination of the LAS and Ethoxylated Polyethylenimine Polymer could provide an improved flowability.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A detergent particle comprising:
(i) from 50% to 90%, by weight of the detergent particle, an alkyl benzene sulphonate anionic surfactant; and
(ii) from 0.1% to 20%, by weight of the detergent particle, an ethoxylated polyethyleneimine.

2. The detergent particle according to claim 1, wherein the alkyl benzene sulphonate anionic surfactant is a C₁₀-C₂₀ linear alkyl benzene sulphonate, and preferably a sodium salt of a C₁₀-C₂₀ linear alkyl benzene sulphonate.

3. The detergent particle according to claim 1, wherein the linear alkyl benzene sulphonate anionic surfactant is present in an amount of from 60% to 95% by weight of the detergent particle.

4. The detergent particle according to claim 1, wherein the ethoxylated polyethyleneimine comprises a polyethyleneimine backbone of weight average molecular weight of between 100 g/mol and 5000 g/mol.

5. The detergent particle according to claim 1, wherein the ethoxylated polyethyleneimine comprises a polyethyleneimine backbone of weight average molecular weight of between 400 g/mol and 1500 g/mol.

6. The detergent particle according to claim 1, wherein the ethoxylated polyethyleneimine comprises polyoxyethylene side chains having an average of from 5 to 40 ethoxy units per side chain bonded to the polyethyleneimine backbone.

7. The detergent particle according to claim 1, wherein the ethoxylated polyethyleneimine comprises polyoxyethylene side chains having an average of from 10 to 30 ethoxy units per side chain bonded to the polyethyleneimine backbone.

8. The detergent particle according to claim 1, wherein the ethoxylated polyethyleneimine comprises:
a polyethyleneimine backbone of weight average molecular weight of between 450 g/mol and 750 g/mol; and
polyoxyethylene side chains having an average of from 15 to 25 ethoxy units per side chain bonded to the polyethyleneimine backbone.

9. The detergent particle according to claim 1, wherein the ethoxylated polyethyleneimine has a total weight average molecular weight of from 7500 g/mol to 17500 g/mol.

10. The detergent particle according to claim 1, further comprises from 0.01% to 5%, by weight of the detergent particle, of sodium sulfosuccinate.

11. The detergent particle according to claim 1, said detergent particle is characterized by: (1) a particle size distribution Dw50 of from 100 μm to 1000 μm; (2) a bulk density of from 400 to 1000 g/L; and (3) a moisture content of from 0 wt % to 3 wt %.

12. The detergent particle according to claim 1, said detergent particle is a solid free-flowing particle.

13. A water-soluble unit dose article, comprising the detergent particle according to claim 1.

14. A cleaning composition in solid form, comprising
from 0.1% to 99% by weight of the composition, of the detergent particle according to claim 1, and
from 0.1% to 99%, by weight of the composition, of an additional ingredient, wherein the additional ingredient is selected from the group consisting of perfume, perfume encapsulates, surfactants, polymers, enzymes, bleach, bleach activators, phosphates, zeolite, silicates, carbonates, sodium chloride, chelants, hueing agents, dye transfer inhibitors, and any combinations thereof.
